(19) United States
(12) Patent Application Publication
(10) Pub. No.: US 2022/0362946 A1
(43) Pub. Date: Nov. 17, 2022

(54) NOZZLE JIG

(71) Applicant: TRIPLE WIN TECHNOLOGY(SHENZHEN) CO.LTD., Shenzhen (CN)

(72) Inventor: XIAO-FENG CHEN, Jincheng (CN)

(21) Appl. No.: 17/551,507

(22) Filed: Dec. 15, 2021

(30) Foreign Application Priority Data
May 17, 2021 (CN) 202121051199.2

(51) Int. Cl. B25J 15/06

(52) U.S. Cl. CPC B25J 15/0616

(57) ABSTRACT

A nozzle jig for sucking products includes a nozzle body and a suction head. The nozzle body includes at least one air channel. The suction head includes a mounting portion and the suction portion. The mounting portion includes a connecting hole. The suction portion includes at least one suction hole and at least one exhaust groove. The suction portion is connected to the nozzle body through the mounting portion. The at least one suction hole, the connecting hole, and the at least one air channel communicate in that sequence. Each of the at least one exhaust groove extends inwardly from a periphery of the suction portion.

### FIELD

The subject matter herein generally relates to a nozzle jig.

### BACKGROUND

The current suction nozzle jig tends to form negative pressure inside the product when sucking the product, which affects the product quality.

Therefore, there is room for improvement within the art.

### BRIEF DESCRIPTION OF THE DRAWINGS

Implementations of present disclosure will now be described, by way of embodiments, with reference to the attached figures.

FIG. 1 is a diagram of an embodiment of a nozzle jig according to the present disclosure.

FIG. 2 is a cross-sectional view of the nozzle jig taken along II-II line of FIG. 1.

FIG. 3 is a bottom view of an embodiment of a nozzle jig according to the present disclosure.

FIG. 4 is a bottom view of another embodiment of a nozzle jig according to the present disclosure.

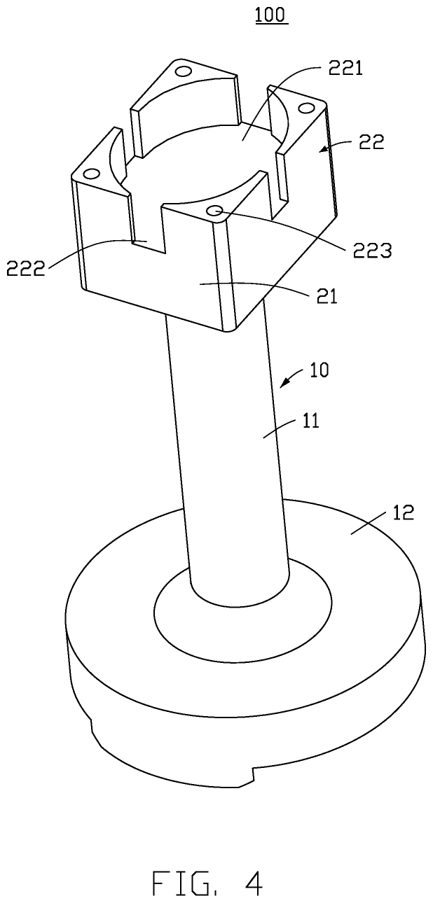

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

An embodiment of a nozzle jig for sucking products includes a nozzle body and a suction head. The nozzle body includes at least one air channel. The suction head includes a mounting portion and a suction portion connected to the mounting portion. The suction portion is connected to the nozzle body through the mounting portion. The mounting portion includes a connecting hole. The suction portion includes at least one suction hole and an exhaust groove. Each suction hole, the connecting hole, and each air channel communicate in that sequence. The exhaust groove extends inwardly from a periphery of the suction portion.

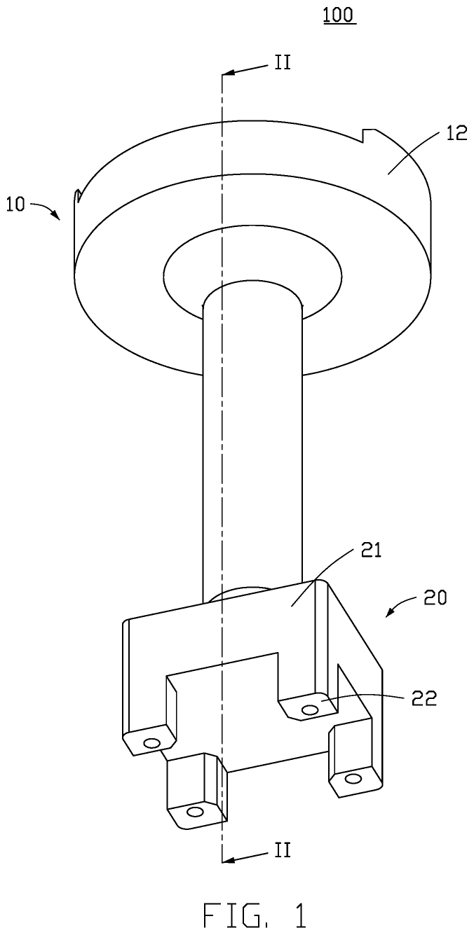

FIG. 1 illustrates an embodiment of the nozzle jig 100. The nozzle jig 100 includes a nozzle body 10 and a suction head 20 connected to the nozzle body 10. The nozzle body 10 is used to connect with a vacuuming device, and the suction head 20 is used to contact a product to suck the product.

In at least one embodiment, the nozzle body 10 and the suction head 20 may be made of stainless steel, which have a good adsorption effect and are not easily deformed. The nozzle body 10 and the suction head 20 may be integrally formed.

The nozzle jig 100 may be used to suck a lens.

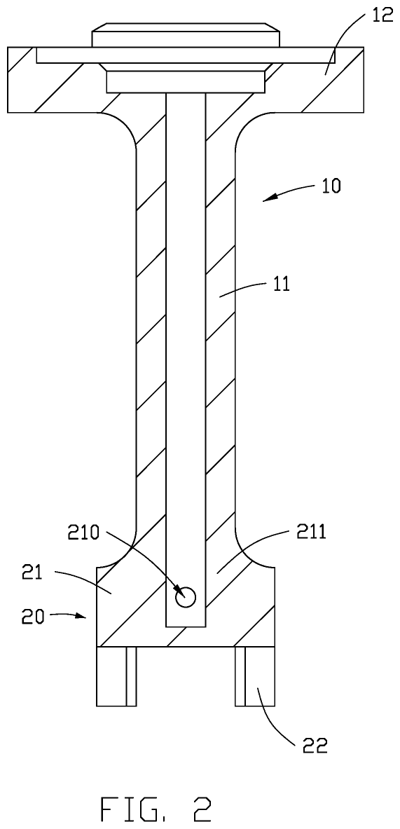

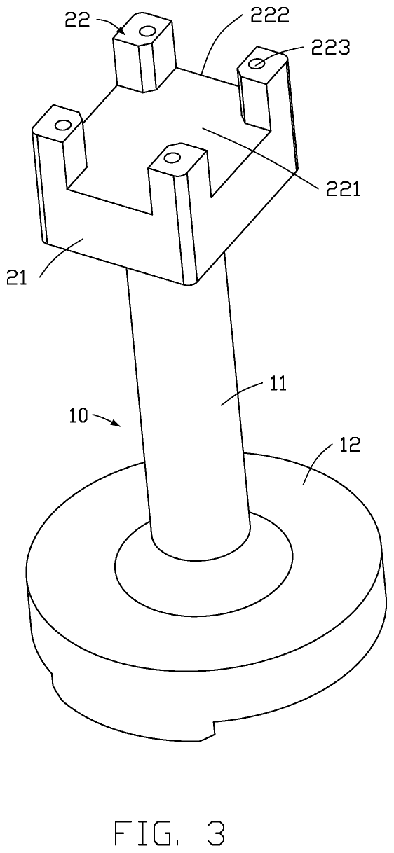

Referring to FIGS. 2 and 3, the nozzle body 10 includes at least one air channel 11, and each air channel 11 penetrates the nozzle body 10 for air flow. In at least one embodiment, the nozzle body 10 includes only one air channel 11, and the air channel 11 may be generally arranged on a central axis of the nozzle body 10. In some embodiments, the nozzle body 10 may include two, three or more air channels 11.

The nozzle body 10 may further include a connecting portion 12 for connecting with an external vacuuming device. In at least one embodiment, the connecting portion 12 may include an internal thread (not shown), and is tightly connected with the external vacuuming device through the internal thread.

In some embodiments, a magnet (not shown) may be mounted on the connecting portion 12 to be magnetically connected to the external vacuuming device.

The suction head 20 includes a mounting portion 21 and a suction portion 22. The mounting portion 21 is connected to the nozzle body 10, and the suction portion 22 is connected to an end of the mounting portion 21 facing away from the nozzle body 10 to suck the product. In at least one embodiment, the mounting portion 21 may be connected to an end portion of the nozzle body 10 away from the connecting portion 12.

In at least one embodiment, the mounting portion 21 and the suction portion 22 may be integrally formed.

The mounting portion 21 includes a connecting hole 210 communicating with each air channel 11. In at least one embodiment, the connecting hole 210 may be in a straight line with a central axis of the air channel 11, so that the airflow can pass through quickly.

A receiving groove 221 is recessed from a surface of the suction portion 22 facing away from the mounting portion 21 toward the mounting portion 21 for receiving a portion of the product.

The suction portion 22 further includes at least one exhaust groove 222. Each exhaust groove 222 communicates with the receiving groove 221 and a periphery of the suction portion 22. In at least one embodiment, the suction portion 22 may include one exhaust groove 222. In some embodiments, the suction portion 22 may include two, three, four or more exhaust grooves 222.

In at least one embodiment, a bottom of each exhaust groove 222 and a bottom of the receiving groove 221 may be on a same plane. In some embodiments, the bottom of each exhaust groove 222 and the bottom of the receiving groove 221 may be not on the same plane, so that each exhaust groove 222 and the receiving groove 221 form a stepped shape.

The suction portion 22 further includes at least one suction hole 223 recessed from the surface of the suction portion 22 facing away from the mounting portion 21 and communicating with the connecting hole 210. The suction hole 223 is used to suck the product. In the illustrated embodiment, the suction portion 22 includes four suction holes 223 and four exhaust grooves 222. One of the suction holes 223 and one of the exhaust grooves 222 are alternately distributed. In some embodiments, the suction portion 22 may be divided into four L-shaped structures by four exhaust grooves 222.

When the nozzle jig 100 is in use, the suction portion 22 abuts the product. The receiving groove 221 receives a portion of the product, and the at least one suction hole 223 abuts the product. When the external vacuuming device is turned on, a negative pressure is formed in the suction hole 223, the connecting hole 210, the air channel 11 to suck the product. The exhaust groove 222 prevents a vacuum from being formed between the product and the whole of the suction portion 22 to damage the product.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A nozzle jig configured for sucking products comprising:
a nozzle body comprising at least one air channel; and
a suction head comprising:
a mounting portion comprising a connecting hole; and
a suction portion comprising at least one suction hole and at least one exhaust groove;
wherein the suction portion is connected to the nozzle body through the mounting portion, the at least one suction hole, the connecting hole, and the at least one air channel communicate in that sequence, each of the at least one exhaust groove extends inwardly from a periphery of the suction portion.

2. The nozzle jig of claim 1, wherein a receiving groove is recessed from a surface of the suction portion facing away from the mounting portion toward the mounting portion, each of the at least one exhaust groove communicates with the receiving groove.

3. The nozzle jig of claim 2, wherein a bottom of each of the at least one exhaust groove and a bottom of the receiving groove are on a same plane.

4. The nozzle jig of claim 2, wherein each of the at least one exhaust groove and the receiving groove form a stepped shape.

5. The nozzle jig of claim 1, wherein the nozzle body further comprises a connecting portion away from the mounting portion.

6. The nozzle jig of claim 1, wherein the connecting portion comprises an internal thread.

7. The nozzle jig of claim 1, wherein a magnet is mounted on the connecting portion.

8. The nozzle jig camera module of claim 1, wherein the mounting portion and the suction portion are integrally formed.

9. The nozzle jig of claim 1, wherein the connecting hole and the air channel are co-axial.
